(19) United States
(12) Patent Application Publication
(10) Pub. No.: US 2007/0202461 A1
(43) Pub. Date: Aug. 30, 2007

(54) Dental bur with a smooth front

(76) Inventors: Shiyu Wang, Alameda, CA (US); Chao Zang, Alameda, CA (US)

Correspondence Address: DAHYEE LAW GROUP, 24301 SOUTHLAND DR., SUITE 405, HAYWARD, CA, 94545, US

(21) Appl. No.: 11/365,086

(22) Filed: Feb. 28, 2006

(51) Int. Cl. A61C 3/02

(52) U.S. Cl. 433/165

(57) ABSTRACT

This invention discloses a dental bur consisting of a shaft, a neck, and a head with a safety front to avoid cutting in its axis direction. In one embodiment, the neck has a rough surface with either cutting grooves or abrasives which constitutes a file, but the head has a smooth surface. In another embodiment, the neck has a smooth surface, but the head has a surrounding rough surface with either grooves or abrasives which constitutes a file. Yet in another embodiment, the neck and a rear part of the head are coated with a rough surface of either cutting grooves or abrasives which constitute a file.

### BACKGROUND OF THE INVENTION

1. Technical Field of the Invention

The present invention relates generally to endodontic equipment and more particularly to a dental bur with a smooth front used in root canal treatment.

2. Description of Prior Art

All human teeth are made up of the same parts: a crown and one or more roots. As shown in FIG. 1, the crown grows above the gums, and the root or roots grow in a socket in the jawbone. The crown is covered by enamel, which is the hardest substance in the body. Enamel is made up of a combination of the minerals calcium and phosphorous. These minerals combine in a crystal structure called apatite. Enamel apatite is harder than bone. Because it has no nerves, this part of the tooth cannot cause pain. The root has a protective outer layer called cementum, a hard, bonelike material. A third hard substance, called dentin, forms a continuous inner shell beneath the crown enamel and the root cementum. The dentin makes up most of the body of the tooth. It too is very similar to bone. The inside of the tooth is filled with a soft tissue called dental pulp which contains nerve fibers, arteries, veins, lymph vessels, and connective tissue. These connect with other blood vessels and nerves outside the tooth through a small opening at the bottom of the tooth's root. The blood vessels supply nutrients and carry away wastes. When irritated, the nerves give the sensation of pain. Tooth decay, a sharp blow, or intense hot or cold may cause tooth pain.

Pain in a tooth is a sign that one may have tooth decay, also known as cavities. A cavity is a hole in the enamel surface of the tooth. It is caused by bacteria present in the mouth. The bacteria that cause tooth decay thrive on some of the same foods one eats.

When they come in contact with cooked starch or sugar, the bacteria turn these foods into acid. The acid slowly causes the tooth's enamel to dissolve. One or more tiny holes, or cavities, are left behind. The term caries is used to describe the decay process, which is in fact a bacterial disease. Caries usually start in the grooves of the molars or in places between the teeth or near the gums. This is because food particles are often caught in such areas, giving the bacteria there plenty of food to turn into acid. If the decay process is not stopped when the cavity is small, the decay may continue through the enamel to the dentin layer, causing a toothache. If the cavity reaches as far as the soft dental pulp, a serious infection may result and permanently damage the tooth.

Large cavities, fractured teeth or broken fillings may cause one's teeth to become overly sensitive and sometimes quite painful. When this occurs, bacteria have reached the dental pulp and an infection starts. Because a fully developed tooth can survive without the pulp, the infected pulp tissues can be entirely removed. A root canal is a procedure where the nerve of the tooth is removed and replaced with a root canal filling. Root canal therapy eliminates the infection by removing the infected pulp tissue, disinfecting and refilling the interior of the tooth. This can prevent widespread infection and permanent damage. The first step in a root canal treatment is to access the dental pulp in the hollow center, also called the pulp chamber, of the tooth by making an opening in the top of the tooth. The second step is to remove, by instrumentation and chemical cleansing, the nerve tissue, bacteria, the organic debris left over from the breakdown of nerve tissue, and bacteria toxins from within the inner aspects of the tooth. The third step is to fill the canals with a rubbery material and a temporary filling is placed in the opening in the crown of the tooth. Finally, the weakened crown of the tooth is rebuilt with a core restoration and protected by a fabricated crown.

The most unpredictable and also the most important step is to properly remove the roof in order to pave the way for the next step in locating the canals and removing the pulp. FIG. 2A illustrates the first step in a root canal treatment, i.e., making an opening in the top of the tooth to gain access to the pulp chamber. This is accomplished by using an electrical dental drill 11 and making an access hole that extends down to the pulp chamber of the tooth. On posterior teeth, the access hole is made on the chewing surface of the tooth. On front teeth, the access hole is made on the tooth's backside.

The dental bur 12 used in the electrical dental drill 11 for root canal treatment is usually called Endo Access Bur or Endo Bur. It is a combination of a round and cone shaped course diamond which allows penetration into the pulp chamber and preparation of the chamber walls. For exemplary purpose, FIG. 3A-3F illustrates six different dental burs. A bur usually consists of four parts, a shaft 31-36 for mechanical connection with the drill body, a neck 3842, a head 46-50, and a point 49-54. The shaft 31-36 is at the driving end of the electrical drill. Its main function is to transmit the torque necessary to rotate the bur and the force necessary to feed the bur into the enamel and dentin. The shaft 31-36 may have any of various shapes—cylindrical, tapered, splined, or rectangular. As shown in FIG. 3A, the neck 37 contains cutting grooves or flutes that run from the point 49 to the shaft 31. In some other type of burs such as these shown in FIG. 3C-FIG. 3F, the neck 39-42 does not have cutting grooves or abrasives. Rather, the cutting grooves or abrasives are embedded in the bur head 45-48. The point 49-54 is on the tip of the bur head. As the bur head moves into the tooth, the point 49-54 cuts away mini-chips of the tooth. Some dental burs, such as these shown in FIG. 3A, FIG. 3C, FIG. 3E, and FIG. 3F, consist of a pointed screw. Some other burs, such as these shown in FIG. 3B and FIG. 3D, consist of particles of a hard abrasive embedded in the bur head. Abrasives commonly used for this purpose are particles of tungsten carbide, boron nitride, silicon carbide, and industrial diamonds.

The common characteristics of the burs according to the prior arts, such as these illustrated in FIG. 3A through FIG. 3F, is that the point performs, at least partially, the cutting function. To make an opening in the crown of a tooth, the dentist applies a force on the electrical drill so that the bur pierces through the enamel, and then through the dentin. Roof removing is a dark box operation. The dentist is usually not quite certain about the thickness of the dentin and the depth of the pulp chamber, and he has to rely on his experience on X-ray estimate and tactile feeling in making the opening. Due to the dark box nature, it is difficult to control the drilling depth. If the force he applies on the electrical drill is larger than necessary, as shown in FIG. 2B, the bur may pierce into the floor of the pulp chamber, or even into the cementum, or even into the bone. When this happens, the natural anatomy of the chamber floor is damaged or destroyed. This may cause infections or permanent damage of the tooth.

The intact natural anatomy of chamber is like the shapes of sinks which automatically lead down into the root canals and make finding canals easy. But damaged or destroyed natural anatomy of the pulp floor may result finding canals difficult and time consuming. Therefore, keeping intact chamber floor when removing roof will be the ideal solution.

To reduce risk of perforating the chamber floor by over-piercing, a block 13, also known as a stop, as illustrated in FIG. 2C, is used to set an estimate depth of drilling. This method is not effective because the thicknesses of the enamel and dentin and the depth of pulp chamber vary from person to person, and vary from tooth to tooth. It is not easy for the dentist to choose a right bur-block to be used in the treatment. If the block is too thick, the roof cannot be pierced through. If the block is not thick enough, the bur may pierce into the chamber floor. Another disadvantage of the bur-block 13 is that it blocks the dentist view while he is controlling the drill.

Therefore, it is desirous that a preventive safety measure is embedded in the head of a bur to avoid any cutting in the direction along the axis of the bur body.

### SUMMARY OF THE INVENTION

The goal of the present invention is to provide dentists with an improved dental bur to avoid improper operation or malpractice caused by over-piercing.

The essence of the present invention is to change the cutting point of a dental bur to a smooth front surface to avoid unnecessary cuttings or grindings on the pulp chamber floor.

In one preferred embodiment, the dental bur has a substantially spherical head or a substantially elliptic spherical head. The front hemisphere has a smooth surface. The back hemisphere and a part of or all of the neck are coated with a rough surface containing cutting grooves or abrasives. The neck may be in the shape of a cylinder or a right circular cone.

In another preferred embodiment, the dental bur has a substantially cylindrical head with a hemispheric front. The hemispheric front has a smooth surface. The side of the head, i.e. the surrounding of the head, has a rough surface containing cutting grooves or abrasives. The radius of the head is larger than the radius of the front end of the neck. The neck has a smooth surface and may have any of various shapes—cylindrical, tapered, splined, or rectangular.

Yet in another preferred embodiment, the dental bur has a hemispheric head with a smooth surface. The hemispheric radius is the same as the radius of the front end of the neck. The neck has a rough surface containing cutting groves or abrasives and may have a shape of a cylinder or a right circular cone.

The advantages of the dental bur according to the present invention are numerous. For example, first, it greatly reduces or virtually eliminates the risk of perforating the pulp floor into jaw bone due to its special design of the smooth front, thus it makes root canal therapy a safer procedure. Second, it ensures the intact pulp chamber, thus makes canals locating more accurately and effectively. Consequently, this will led to a higher treatment quality with less post-operation pain. Third, it makes locating all the canals easier and faster, thus shortens the operation time.

### BRIEF DESCRIPTION OF THE DRAWINGS

FIG. 1 is a schematic diagram illustrating the structure of a molar.

FIG. 2A through FIG. 2C are schematic diagrams illustrating the step to make an opening in the molar for root canal treatment according to prior art.

FIG. 3A through FIG. 3F are schematic diagrams illustrating various endodontic burs according to prior art.

FIG. 4A through FIG. 4D are schematic diagrams illustrating the step to enlarge an opening in the molar for root canal treatment according to the present invention.

FIG. 5A through FIG. 5G are schematic diagrams illustrating various endodontic burs according to the present invention.

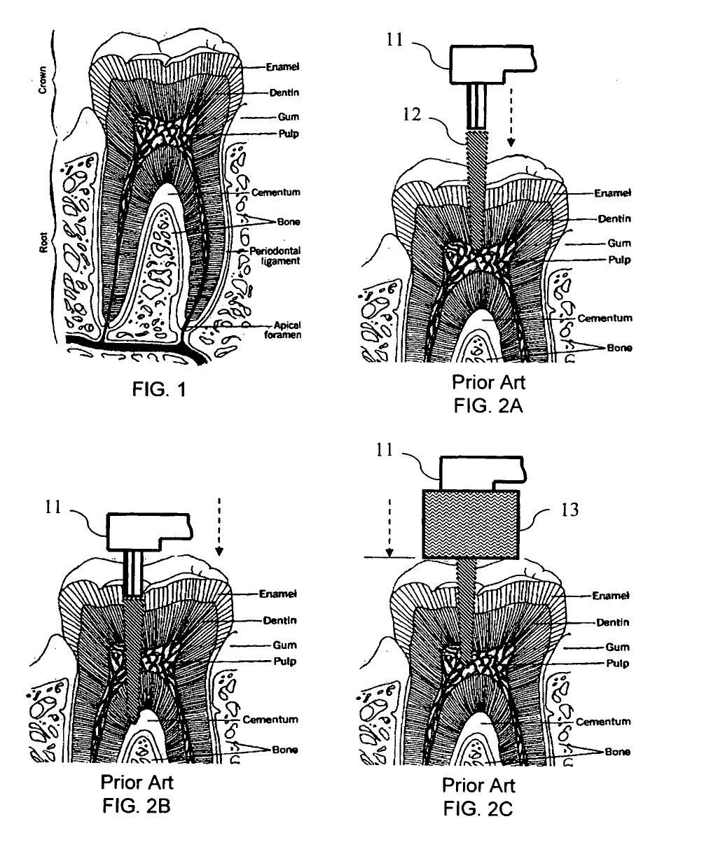

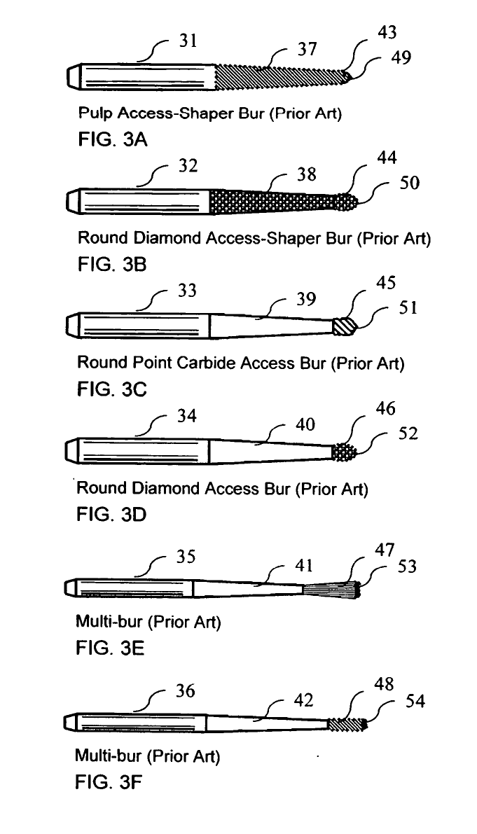

### DETAILED DESCRIPTION OF THE INVENTION

The present invention is best understood by referring to the accompanying figures and the detailed description set forth herein. Embodiments of the invention are discussed below with reference to the figures. However, those skilled in the art will readily appreciate that the description given herein with respect to the figures is for explanatory purposes as the invention extends beyond these limited embodiments.

Root canal therapy (RTC) of adult molars, especially the calcified narrow molars, is challenging for both dentists and patients. Long exhausting procedure makes it a painful experience for patients, not mention their fear of pain. The most unpredictable and also the most important step is to properly remove of the roof of the tooth in order to pave the way for locating all canals and remove the entire pulp. Roof removing is a dark box operation. The depth of cutting depends on X-ray estimating and tactile feeling. Due to the nature of dark box, the natural anatomy of the chamber floor is likely to be damaged or destroyed or even the pulp floor is perforated and is drilled through into the jaw bone. An intact natural anatomy of chamber is like the shapes of sinks which automatically lead down into the root canals and make finding canals easy. On the contrary, a damaged or destroyed anatomy of the chamber floor may result in finding canals difficult and time consuming, which is exhausting for both patients and dentists. Therefore, keeping intact chamber floor while removing roof will be the ideal solution.

The essence of the present invention is to reform the cutting point of a dental bur into a smooth surface, preferably a hemispherical surface, to avoid unnecessary cuttings on the lower dentin, cementum, or bone beneath the cementum.

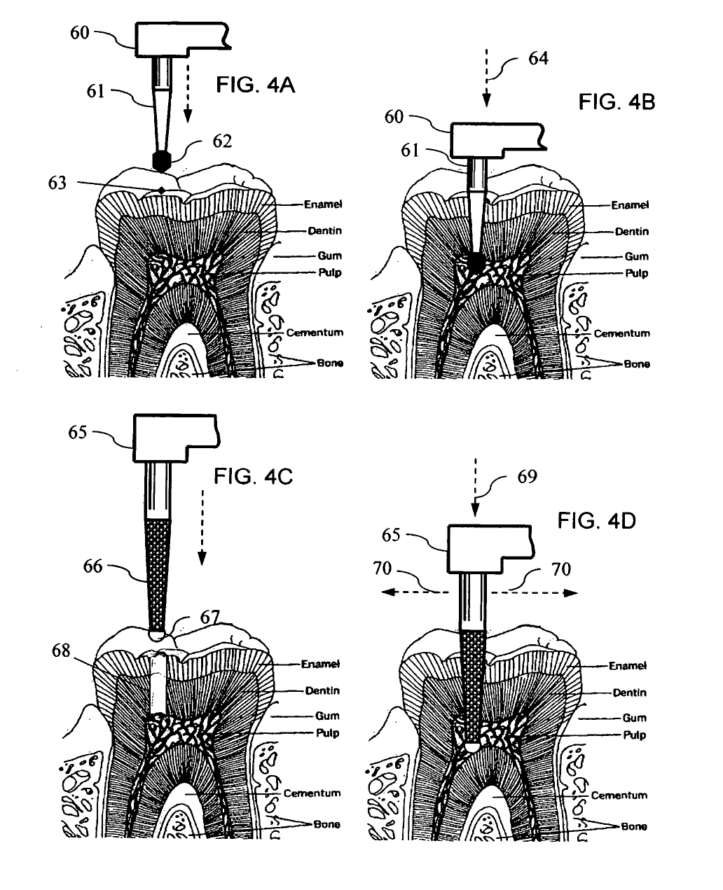

FIG. 4A through FIG. 4D illustrates the roof removal step in the RTC procedure according to this invention. First, as shown in FIG. 4A, the dentist is to make a hole at a position 63 on the roof using an electrical drill 60 with an access bur 61. The access bur 61 has a head 62 which is sharp enough to penetrate the enamel and dentin. As shown in FIG. 4B, when the dentist applies a force 64 on the drill 60, the bur 61 pierces slowly into the roof. Second, as soon as the roof is pierced through, the dentist withdraws the access bur 61 from the tooth. Third, the dentist inserts a bald head bur 66 into the hole 68 which was made with the access bur 61. Although it is called bald head bur, it is actually a file with smooth front. In one preferred embodiment of the present invention, the bald head bur 66 is powered by the electrical drill 65. It has a hemispherical head 67 and a rough neck 66 coated with cutting grooves or abrasives. The radius of the head 67 of the bald head bur 66 should be slightly less than that of the head 62 of the access bur 61. As shown in FIG. 4D, when the dentist applies a force 69 on the drill 65 down to the tooth, or applies a force 70 which moves the neck 66 away from the axis of the bur 66, the rough neck 66 enlarges the initial opening, i.e. the hole 68. Because the bur head 67 is smooth, even when it touches the dentin of the chamber floor, it will not cut or damage it.

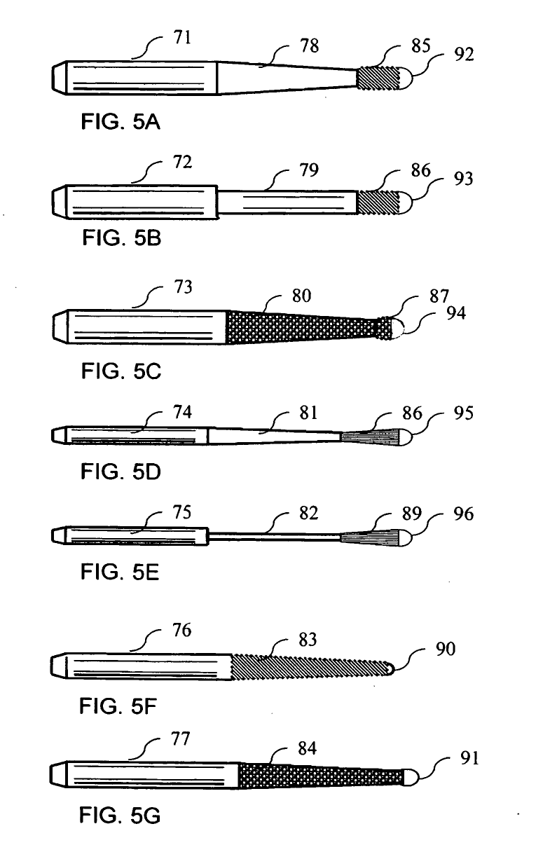

Several other equivalently preferred embodiments are developed. FIG. 5A through FIG. 5G are just examples. The bur or file according to the present invention consists of three parts, a shaft 71-77 for mechanical attachment to the electrical drill, a neck 78-84, and a head 85-91 with smooth front surface 90-96. Note that the bur or file does not have a cutting tip or point. Rather it has a substantially hemispherical front 90-96. Therefore, when it is pushed forward, its front does not cut in the pushing direction, i.e. the direction of the bur axis. The shaft 71-77 is at the driving end of the electrical drill. Its main function is to transmit the torque necessary to rotate the bur and the force necessary to cut the enamel and dentin using its rough part either on the neck or on the head. The shaft 71-77 may have any of various shapes—cylindrical, tapered, splined, or rectangular.

FIG. 5A illustrates a file which has a shaft 71, a tapered neck 78 with a smooth surface, a cylindrical head 85 with a substantially hemispherical front 92. The head 85 is connected to the narrow end of the neck 78, and the radius of the head 85 is slightly larger than that of the narrow end of the neck 78. The head 85 has a rough surface containing cutting grooves or abrasives. The front 92, however, is smooth to avoid cutting in the axis direction.

FIG. 5B illustrates another file which has a shaft 72, a cylindrical neck 79 with a smooth surface, a cylindrical head 86 with a substantially hemispherical front 93. The radiuss of the cylindrical neck 79, the cylindrical head 86 and the hemispheric front 93 are identical. The cylindrical head 86 has a rough surface containing cutting grooves or abrasives. The front 93, however, is smooth to avoid cutting in the axis direction.

FIG. 5C illustrates another file which has a shaft 73, a tapered neck 80, a substantially spherical head 87 with a substantially hemispherical front 94. The narrow end of the neck 80 is connected to the head 87. The radius of the head 87 is larger than the radius of the narrow end of the tapered neck 80. The rear part of the head 87 and the tapered neck 80 contains cutting grooves or abrasives. The front 94, however, is smooth to avoid cutting in the axis direction.

FIG. 5D illustrates a file which has a shaft 74, a tapered neck 81 with a smooth surface, a tapered head 88 with a substantially hemispherical front 95. The narrow end of the head 88 is connected to the narrow end of the neck 81. The wide end of the head 88 is connected to the front 95. The head 88 has a rough surface containing cutting grooves or abrasives. The front 95, however, is smooth to avoid cutting in the axis direction.

FIG. 5E illustrates a file which has a shaft 75, a cylindrical neck 82 with a smooth surface, a tapered head 89 with a substantially hemispherical front 96. The narrow end of the head 89 is connected to the neck 82. The wide end of the head 89 is connected to the substantially hemispherical front 96. The head 89 has a rough surface containing cutting grooves or abrasives. The front 96, however, is smooth to avoid cutting in the axis direction.

FIG. 5F illustrates another file which has a shaft 76, a tapered neck 83 with a substantially hemispherical front 90. The wide end of the tapered neck 83 is connected to the shaft. The radius of the front 90 and the radius of the narrow end of the tapered neck 83 are identical. The tapered neck 83 has a rough surface containing cutting grooves or abrasives. The entire hemispherical front 90, however, is smooth to avoid cutting in the axis direction.

FIG. 5G illustrates another file which has a shaft 77, a tapered neck 84, and a substantially spherical front 91. The wide end of the tapered neck 84 is connected to the shaft 77. The narrow end of the tapered neck 84 is connected to the spherical front 91. The radius of the spherical front 91 is slightly larger than the radius of the narrow end of the tapered neck 84. The tapered neck 84 has a rough surface containing cutting grooves or abrasives. The entire spherical front 91, however, is smooth to avoid cutting in the axis direction.

In the embodiments illustrated above, the abrasives commonly used are particles of tungsten carbide, boron nitride, silicon carbide, and industrial diamonds.

The bur or file according to this invention is used for enlarging an opening. It is not used to originate holes. The proper use of the bur or file will virtually eliminate the risk of perorating pulp floor and will keep the natural anatomy of the dental pulp floor intact. Therefore, it will also make locating canals quicker and more accurate. Further, this technique will also significantly reduce long exhausting treatment time. In addition, both patients and dentists may feel less stressful and less exhausted in RTC.

Although the invention is described herein with reference to the preferred embodiment, one skilled in the art will readily appreciate that other applications may be substituted for those set forth herein without departing from the spirit and scope of the present invention.

Accordingly, the invention should only be limited by the Claims included below.

1. A dental apparatus used for enlarging an opening made in a tooth comprising: a shaft, a round neck having a rough surface, and a round head having a smooth surface.

2. The dental apparatus of claim 1, wherein the rough surface contains cutting grooves.

3. The dental apparatus of claim 1, wherein the rough surface is embedded with abrasives.

4. The dental apparatus of claim 3, wherein the abrasives comprise any of: tungsten carbide, boron nitride, silicon carbide, and industrial diamonds.

5. The dental apparatus of claim 1, wherein the round neck is cylindrical.

6. The dental apparatus of claim 5, wherein the round head is substantially hemispherical, and wherein the round neck's radius is substantially identical to the round head's radius.

7. The dental apparatus of claim 5, wherein the round head is substantially spherical, and wherein the round neck's radius is less than the round head's radius.

8. The dental apparatus of claim 1, wherein the round neck is tapered, with its narrow end connected to the round head, and with its wide end connected to the shaft.

9. The dental apparatus of claim 8, wherein the round head is substantially hemispherical, and wherein the narrow end's radius is substantially identical to the round head's radius.

10. The dental apparatus of claim 8, wherein the round head is substantially spherical, and wherein the narrow end's radius is less than the round head's radius.

11. A dental apparatus for enlarging an opening made in a tooth comprising: a shaft, a neck having smooth surface, and a head having a smooth round front and a rough surrounding surface, wherein the neck is thinner than the head.

12. The dental apparatus of claim 11, wherein the rough surrounding surface contains cutting grooves.

13. The dental apparatus of claim 11, wherein the rough surrounding surface is embedded with abrasives.

14. The dental apparatus of claim 13, the abrasives comprise any of: tungsten carbide, boron nitride, silicon carbide, and industrial diamonds.

15. The dental apparatus of claim 11, wherein the head is substantially cylindrical, having a substantially hemispherical front, and wherein the head's cylindrical radius is substantially identical to the hemispherical front's radius.

16. A dental apparatus for enlarging an opening made in a tooth comprising: a shaft, a neck, and a head, wherein the neck is thinner than the head, and wherein the head is substantially spherical, its front hemisphere having a smooth surface and its back hemisphere having a rough surface.

17. The dental apparatus of claim 16, wherein the rough surrounding surface contains cutting grooves.

18. The dental apparatus of claim 16, wherein the rough surrounding surface is embedded with abrasives.

19. The dental apparatus of claim 16, wherein the neck has a same rough surface as that of the back hemisphere.

20. The dental apparatus of claim 19, wherein the neck is tapered, with its narrow end connected to the back hemisphere and its wide end connected to the shaft.
